(19) United States
(12) Patent Application Publication
(10) Pub. No.: US 2007/0127575 A1
(43) Pub. Date: Jun. 7, 2007

(54) METHOD AND RELATED APPARATUS FOR MOTION ESTIMATION

(76) Inventor: Cheng-Tsai Ho, Tai-Chung City (TW)

Correspondence Address: NORTH AMERICA INTELLECTUAL PROPERTY CORPORATION, P.O. BOX 506, MERRIFIELD, VA, 22116, US

(21) Appl. No.: 11/549,128

(22) Filed: Oct. 13, 2006

Related U.S. Application Data
(63) Continuation-in-part of application No. 10/904,421, filed on Nov. 9, 2004, now Pat. No. 7,145,951.

(30) Foreign Application Priority Data
Nov. 11, 2003 (TW) 092131565

(51) Int. Cl. H04N 11/02; H04B 1/66

(52) U.S. Cl. 375/240.16; 375/240.27

(57) ABSTRACT

Disclosed is a motion estimation method for selecting a target motion vector from a plurality of candidate motion vectors in a search range of a target picture for an encoding block having a lot of pixels in a picture is disclosed. The method comprises: utilizing a distortion function to calculate difference between the pixels of the encoding block and the pixels in the search range of a target picture to generate at least one distortion value; utilizing an entropy function to calculate the distribution of the difference between the pixels of the encoding block and the pixels in the search range of blocks corresponding to candidate motion vectors to generate at least one distribution values; performing an mathematics operation to the distortion values and the distribution values to generate at least one operation value; and selecting the target motion vector according to the operation value.

### CROSS REFERENCE TO RELATED APPLICATIONS

This application is a continuation-in-part of applicant's earlier application, Ser. No. 10/904,421, filed 2004 Nov. 9, and is included herein by reference.

### BACKGROUND OF INVENTION

1. Field of the Invention

The invention relates to a method and related apparatus for motion estimation in a video compression system, and more particularly, to a method and related apparatus for motion estimation using a cost function.

2. Description of the Prior Art

As multimedia technology develops, more and more standards related to video compression have been introduced. For instance, various versions of MPEG are standards for digital video compression, and ITU H.261, H.263, ISO 10918 are other examples.

MPEG defines a standard for digital video compression. A motion picture is composed of a series of pictures, and each picture can be regarded as a two-dimensional array composed of a plurality of pixels, which is called a frame of the motion picture. MPEG standard defines four types of different pictures: I picture, which is encoded without referring to any other pictures; P picture, which is encoded through motion estimation referring to a previous I picture or P picture; B picture, which is encoded through motion estimation referring to a following I picture or P picture; and D picture, which is used in fast forward search mode.

Video compression systems complying with the standards mentioned above utilize motion estimation technology based on blocks or macroblocks in order to reduce the temporal redundancy. During motion estimation, for a current encoding block in a current picture, the video compression system will find a best matching block, which is the most similar to the current encoding block, from a target picture. In this case, for the current encoding block, the video compression system can store (or transmit) the motion vector and the residual calculated to represent data included in the current encoding block (wherein the residual represents a pixel value difference between the current encoding block and the best matching block).

According to the prior art, when the video compression system searches for the best matching block from a search range, a cost function called “sum of absolute difference” is used, which is obtained as follows:

$$SAD ( x , y ) = {\sum }_{i = i 0}^{i 1} {\sum }_{j = j 0}^{ j 1} \vert {C}_{i , j} - {P}_{i + x , j + y} \vert$$

(x, y) is a candidate motion vector in the search range, (i1−i0)*(j1−j0) is the size of the current encoding block, Cᵢⱼ is a pixel in the current encoding block, and P_{i+x,j+y} is a pixel in the search range of the target picture.

The conventional video compression system finds a candidate motion vector (x, y), which minimizes the cost function, to be the optimal motion vector (x1, y1) of the current encoding block. Such a method is for finding the best matching block having the smallest residual so that the residual can be better compressed. However, the found optimal motion vector (x1, y1) may not result in better compression; thus U.S. Pat. No. 5,847,776 discloses another cost function that considers not only the sum of absolute difference but also the volume of the motion vector during the searching for the optimal motion vector so that a balance can be kept between the found optimal motion vector and a residual corresponding to it.

However, most video compression systems utilize a discrete cosine transform (DCT) algorithm to transform the residual in a spatial domain into a frequency domain during the compressing of the residual. Then the video compression system utilizes a corresponding quantization matrix and a quantization step Qp, which changes according to a bit rate selected by the system, to quantize the residual in the frequency domain. Since the quantized matrix is a two-dimensional matrix, the system further utilizes zig-zag scan or alternate scan to scan the quantized two-dimensional data into one-dimensional data. Finally, the video compression system operates variable length coding.

During variable length coding, the smaller the frequency distribution range of the residual in the frequency domain is, the shorter the code length of the encoded residual is (i.e. the better compressed the residual is). In other word, the smaller of the frequency distribution range of the residual means that the degree of disorder or randomness of the residual is smaller, i.e. entropy (a measurement or function of disorder or randomness) of the residual is smaller. However, neither the prior art nor the method disclosed in U.S. Pat. No. 5,847,776 can find the best matching block with the residual that has the smallest frequency distribution range or has the smaller entropy. Even in the case that the found best matching block results in a residual in the spatial domain having the smallest sum of absolute difference, after it has been operated on by DCT, quantization process, zig-zag scan (or other scan methods), variable length coding, the residual may not necessarily have the shortest code length, meaning that the optimal compression cannot be achieved. This is a main problem in the prior art.

Recently, a new MPEG technique H.264 is disclosed, which calculates bit rate for each candidate motion vector to determine an optimal motion vector. However, such method will cause heavy calculation loading and is time consuming for processing such calculation.

### SUMMARY OF INVENTION

It is therefore a primary objective of the claimed invention to provide a method and related apparatus utilizing an entropy function and a distortion function to solve the problems mentioned above.

The disclosed embodiment of the present invention discloses a motion estimation method for selecting a target motion vector from a plurality of candidate motion vectors in a search range of a target picture for an encoding block having a lot of pixels in a picture is disclosed. The method comprises: utilizing a distortion function to calculate difference between the pixels of the encoding block and the pixels in the search range of the target picture to generate at least one distortion value; utilizing an entropy function to determine the distribution or variation of the difference between the pixels of the encoding block and the pixels in the search range of blocks corresponding to candidate motion vectors to generate at least one distribution values; operating the distortion values and the distribution values to generate at least one operation value; and selecting the target motion vector according to the operation value.

The disclosed embodiment also discloses a motion estimation device for selecting a target motion vector from a plurality of candidate motion vectors in a search range for an encoding block having a lot of pixels. The device comprises: a distortion calculator for utilizing a distortion function for calculating difference between the pixels of the encoding block and the pixels in the search range of a target picture to generate at least one distortion value; a spatial variation calculating module for utilizing an entropy function to calculate the distribution or variation of the difference between the pixels of the encoding block and the pixels in the search range corresponding to candidate motion vectors to generate at least one distribution value; and a motion vector determining module, coupled with the distortion calculator and the spatial variation calculating module, for operating the distortion value and the distribution value to generate at least one operation value and for determining the target motion vector according to the operation value.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a flowchart of a method according to the present invention.

FIG. 2 illustrates a motion estimation device in the video compression system according to the present invention.

### DETAILED DESCRIPTION

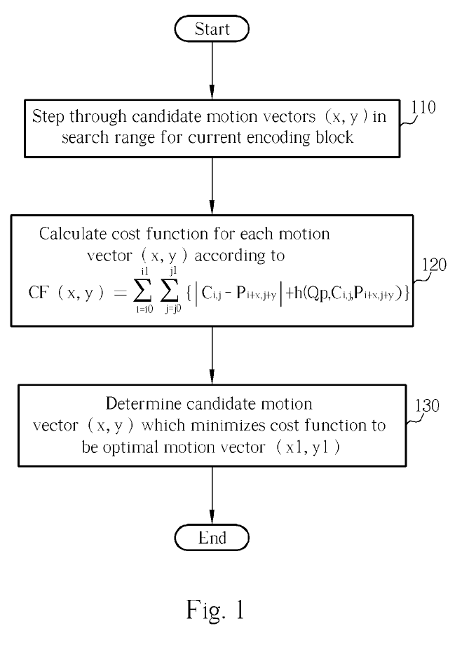

Please refer to FIG. 1 showing a flowchart of a method according to the present invention. The method can be used in a video compression system for motion estimation. The video compression system divides a current picture into a plurality of blocks. The method is shown in FIG. 1 as follows:

Stepl 110: Step through a plurality of candidate motion vectors (x, y) in a search range for a current encoding block of a current picture. The current encoding block includes (i1−i0)*(j1−j0) pixels.

Step 120: Calculate a cost function for each candidate motion vector (x, y) as follows:

$$CF ( x , y ) = {\sum }_{i = i 0}^{i 1} {\sum }_{j = j 0}^{ j 1} \{ \vert {C}_{i , j} - {P}_{i + x , j + y} \vert + h ( Qp , {C}_{i , j} , {P}_{i + x , j + y} ) \}$$

wherein Cᵢⱼ is a pixel in the current encoding block, P_{i+x,j+y} is a pixel in the search range of the target picture, and Qp is a quantization step. As well-known by persons skilled in the art,

$${\sum }_{i = i 0}^{i 1} {\sum }_{j = j 0}^{ j 1} \vert {C}_{i , j} - {P}_{i + x , j + y} \vert$$

is a distortion function for computing the difference between the pixels of the encoding block and the pixels in the search range of a target picture.

Step 130: Determine the candidate motion vector (x, y) in the search range that meet a desired condition, such as minimizes the cost function, to be a target motion vector (x1, y1) of the current encoding block. Wherein, the target motion vector which minimizes the cost function may regard as an optimal motion vector.

The present invention is different from the prior art because the cost function used in the present invention considers not only a sum of absolute difference calculated from a distortion function (i.e. member |C_{i,j}−P_{i+x,j+y}|) but also other members corresponding to the quantization step Qp and the distribution of the sum of absolute difference (i.e. member h(Qp,C_{i,j},P_{i+x,j+y})). It should be noted that,

$${\sum }_{i = i 0}^{i 1} {\sum }_{j = j 0}^{ j 1} \vert {C}_{i , j} - {P}_{i + x , j + y} \vert$$

is just an example for distortion function, and does not mean to limit the scope of the present invention. Other similar functions such as Sum of Squared Difference (SSD) or Sum of Absolute Transform Difference (SATD) can also be used for the distortion function in the present invention.

For instance, function h(Qp,C_{i,j},P_{i+x,j+y}) can be represented as K×f(Qp)×g(|C_{i,j}−P_{i+x,j+y}|), wherein K is a constant. Therefore, function f(Qp) is a monotonic increasing function, meaning that the larger Qp is, the larger function f(Qp) is. In other words, f(Qp) can be regarded as an amplifying factor for amplifying the effect of g(|C_{i,j},P_{i+x,j+y}|). Therefore, g(|C_{i,j},P_{i+x,j+y}|) still can be used to the present invention even if f(Qp) is removed. In this case h(Qp,C_{i,j},P_{i+x,j+y}) has a more important influence on the cost function. Function g(|C_{i,j}−P_{i+x,j+y}|) is for roughly calculating the variation of the pixel difference between the current encoding block and a block corresponding to the current candidate motion vector (x, y) (i.e. representing the distribution of the residual in the frequency domain). Generally, the smaller

$${\sum }_{i = i 0}^{i 1} {\sum }_{j = j 0}^{ j 1} g ( \vert {C}_{i , j} - {P}_{i + x , j + y} \vert )$$

is, the better compressed the residual resulting from the candidate motion vector (x, y) and operated by DCT, quantization process, zig-zag scan (or other scan methods), and variable length coding.

Here is an example of function g(|C_{i,j}−P_{i+x,j+y}|):

$$g ( \vert {C}_{i , j} - {P}_{i + x , j + y} \vert ) = \{ \begin{matrix}\vert {C}_{i , j} - {P}_{i + x , j + y} \vert - ad\_max , & if \vert {C}_{i , j} - {P}_{i + x , j + y} \vert > ad\_max , & ( i , j ) \neq ( 0 , 0 ) \\ ad\_min - \vert {C}_{i , j} - {P}_{i + x , j + y} \vert , & if \vert {C}_{i , j} - {P}_{i + x , j + y} \vert < ad\_min , & ( 1 , j ) \neq ( 0 , 0 ) \\ 0 , & else & \end{matrix}$$

Wherein ad_max and ad_min are shown as follows:

$$ad\_max = \{ \begin{matrix}\vert {C}_{0 , 0} - {P}_{x , y} \vert , & if ( i , j ) = ( 0 , 0 ) \\ max [ \vert {C}_{i , j} - {P}_{i + x , j + y} \vert , ad\_max ] , & if ( i , j ) \neq ( 0 , 0 )\end{matrix} \\ ad\_min = \{ \begin{matrix}\vert {C}_{0 , 0} - {P}_{x , y} \vert , & if ( i , j ) = ( 0 , 0 ) \\ min [ \vert {C}_{i , j} - {P}_{i + x , j + y} \vert , ad\_min ] , & if ( i , j ) \neq ( 0 , 0 )\end{matrix}$$

In this example, whenever a function g(|C_{i,j}−P_{i+x,j+y}|) corresponding to a set of (i, j) is calculated, ad_max and ad_min can be refreshed for the later calculation of functions g(|C_{i,j}−P_{i+x,j+y}|) corresponding to (i, j).

Take the case of a 2*3 block, (i1−i0)=2, (j1−j0)=3. Imagine if there are only two candidate motion vectors in the search range respectively corresponding to a first block and a second block, the absolute value of the pixel difference between the current encoding block and the first block {8, 9, 6, 8, 7, 6}, and the absolute value of the pixel difference between the current encoding block and the second block {5, 10, 4, 22, 0, 0}. Calculating the cost function by the sum of absolute difference according to the prior art, the cost functions of the first block and the second block are as follows:

first block: 8+9+6+8+7+6=44

second block: 5+10+4+22=41

Therefore the second block is taken as the best matching block for the current encoding block according to the prior art.

However, according to the present invention, where one assumes K=1, f(Qp)=1, the cost functions of the first block and the second block are as follows:

first block: [8+0]+[9+(9−8)]+[6+(8−6)]+[8+0]+[7+0]+[6+0]=47

second block: [5+0]+[10+(10−5)]+[4+(5−4)]+[22+(22−10)]+[0+(4−0)]+[0+0]=63

Obviously, according to the present invention, the first block is taken as the best matching block for the current encoding block. This is very different from the prior art.

According to function g(|C_{i,j}−P_{i+x,j+y}|) described above, the cost function disclosed in the present invention can be simplified as follows:

$$CF ( x , y ) = {\sum }_{i = i 0}^{i 1} {\sum }_{j = j 0}^{ j 1} \vert {C}_{i , j} - {P}_{i + x , j + y} \vert + K \cdot f ( Qp ) \cdot ( ad\_max - ad\_min )$$

Wherein ad_max and ad_min are respectively the maximum and the minimum of |C_{i,j}−P_{i+x,j+y}|, between (i, j)=(i0, j0) and (i, j)=(i1, j1).

The above-mentioned method can be summarized as follows:

First, utilize a distortion function such as |C_{i,j}−P_{i+x,j+y}| to calculate difference between the pixels of the encoding block and the pixels in the search range of a target picture to generate at least one distortion value.

Second, utilize an entropy function such as h(Qp,C_{i,j},P_{i+x,j+y}) or g(|C_{i,j}−P_{i+x,j+y}|) to determine the distribution or variation of the difference between the pixels of the encoding block and the pixels of blocks corresponding to candidate motion vectors to generate at least one distribution values.

Third, sum up the distortion values and the distribution values to generate at least one sum value. For example, utilize a cost function such as

$$CF ( x , y ) = {\sum }_{i = i 0}^{i 1} {\sum }_{j = j 0}^{ j 1} \{ \vert {C}_{i , j} - {P}_{i + x , j + y} \vert + h ( Qp , {C}_{i , j} , {P}_{i + x , j + y} ) \} , \\ or$$

$$CF ( x , y ) = {\sum }_{i = i 0}^{i 1} {\sum }_{j = j 0}^{ j 1} \{ \vert {C}_{i , j} - {P}_{i + x , j + y} \vert + K \cdot g ( {C}_{i , j} , {P}_{i + x , j + y} ) \}$$

to calculate the sum value.

Fourth, select the target motion vector according to the sum value.

It should be noted that, although the third step sum up the distortion value and the distribution value to generate at least one sum value, and the fourth step selects the target motion vector according to the sum value, but it does not mean to limit the scope of the present invention. The present invention allows the target motion vector being selected according to any combination of the distortion value and the distribution value. That is, the distortion value and the distribution value can be operated via any mathematics operation, for example including addition, subtraction, multiplication, division, exponentiation, mean square, or root mean square etc., to generate at least one operation value in the third step, and the fourth step can select the target motion vector according to the operation value. That also falls in the scope of the present invention.

That is, according to the present invention, the larger distribution range of the pixel difference between the current encoding block and a block corresponding to a candidate motion vector (x, y) in the target picture (in the example above, the larger the difference between the maximum and the minimum), the larger the cost function is so that it is less easier to be selected as the best matching block for the current encoding block.

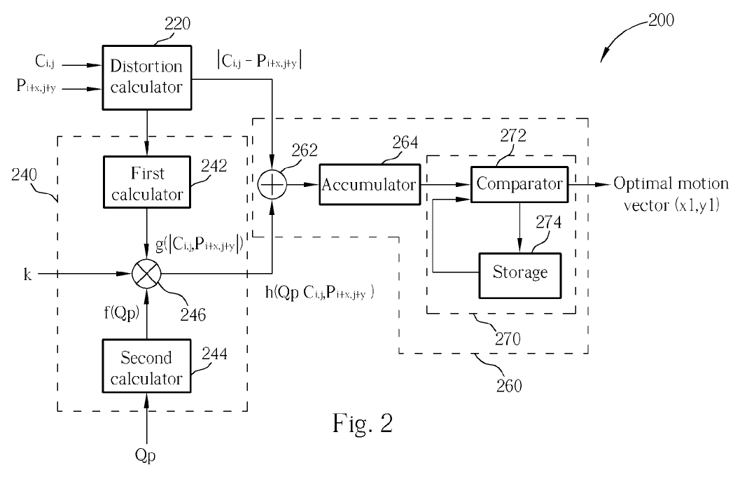

Please refer to FIG. 2 showing a motion estimation device 200 in the video compression system according to the present invention. The video compression system divides a current picture into a plurality of blocks. For a current encoding block in the current picture, the device 200 can determine an optimal motion vector (x1, y1) from a plurality of candidate motion vectors (x, y) in a search range, wherein the current encoding block includes (i1−10)*(j1−j0) pixels. As shown in FIG. 2, the device 200 includes an distortion calculator 220 for calculating distortion between the pixels of the encoding block and the pixels in the search range of a target picture. For example, the distortion can be obtained from |C_{i,j}−P_{i+x,j+y}|, wherein Cᵢⱼ is a pixel in the current encoding block, and P_{i+x,j+y} is a pixel in the search range of the target picture; a spatial variation calculating module 240 for calculating distribution value by utilizing an entropy function such as h(Qp,C_{i,j},P_{i+x,j+y}), wherein Qp is a quantization step; and a motion vector determining module 260 coupled with the distortion calculator 220 and the spatial variation calculating module 240 for summing up the distortion values and the variation values to generate at least one sum value and for determining the target motion vector according to the sum value. For example, the spatial variation calculating module 240 calculates a cost function as follows,:

$${\sum }_{i = i 0}^{i 1} {\sum }_{j = j 0}^{ j 1} \{ \vert {C}_{i , j} - {P}_{i + x , j + y} \vert + h ( Qp , {C}_{i , j} , {P}_{i + x , j + y} ) \}$$

For instance, similar to the above description, function h(Qp,C_{i,j},P_{i+x,j+y}) can be represented as K×f(Qp)×g(|C_{i,j}−P_{i+x,j+y}|); therefore in device 200, the spatial variation calculating module 240 includes a first calculator 242 for calculating function g(|C_{i,j}−P_{i+x,j+y}|), a second calculator 244 for calculating function f(Qp), and a multiplier 246 coupled with the first calculator 242 and the second calculator 244 for calculating K×f(Qp)×g(|C_{i,j}−P_{i+x,j+y}|). As described above, f(Qp)can be regarded as an amplifying factor for amplifying the effect of g(|C_{i,j},P_{i+x,j+y}|). Therefore, g(|C_{i,j},P_{i+x,j+y}|) still can be used to the present invention even if f(Qp)is removed.

The motion vector determining module 260 includes an adder 262 coupled with the distortion calculator 220 and the spatial variation calculating module 240 for adding one of the distortion value and one of the distribution value (for example, |C_{i,j}−P_{i+x,j+y}|+h(Qp,C_{i,j},P_{i+x,j+y}), an accumulator 264 coupled with the adder 262 for calculating thesum of the distortion values and distribution values (for example,

$${\sum }_{i = i 0}^{i 1} {\sum }_{j = j 0}^{j 1} \{ \vert {C}_{i , j} - {P}_{i + x , j + y} \vert + h ( Qp , {C}_{i , j} , {P}_{i + x , j + y} ) \} ) ,$$

and a determiner 270 coupled with the accumulator 246 for determining the candidate motion vector (x, y), which meet a desired condition such as minimizes the cost function, to be the optimal motion vector (x1, y1) of the current encoding block. Wherein, the target motion vector which minimizes the cost function may regard as an optimal motion vector

For storing a smaller value of the sum value and comparing different sum values generated from different candidate motion vectors as shown in FIG. 2, the determiner 70 includes a comparator 272 coupled with the accumulator 264 for outputting the target motion vector (x1, y1), and a storage 274 coupled with the comparator 272 for storing the smaller value of the sum values.

In contrast to the prior art, the optimal motion vector in the search range of the current encoding block can be obtained according to a cost function different from that in the prior art. Since the cost function of the present invention is influenced by the variation of the pixel difference between the current encoding block and a block corresponding to the current candidate motion vector (x, y), the present invention can provide a better compression efficiency on the residual corresponding to the optimal motion vector after processing (by DCT, quantization process, zig-zag scan and variable length coding).

Also, comparing with the above-mentioned H.264, the present invention does not need to calculate the bit rate of each candidate motion vectors and only needs a distortion function and an entropy function to select a target motion vector. Thus the calculating loading can be decreased and the speed can be increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A motion estimation method for selecting a target motion vector from a plurality of candidate motion vectors in a search range of a target picture for an encoding block having a lot of pixels, the method comprising;
(a) utilizing a distortion function to calculate difference between the pixels of the encoding block and the pixels in the search range to generate at least one distortion value;
(b) utilizing an entropy function to determine the distribution of the difference between the pixels of the encoding block and the pixels in the search range corresponding to candidate motion vectors to generate at least one distribution value;
(c) performing an mathematics operation to the distortion value and the distribution value to generate at least one operation value; and
(d) selecting the target motion vector according to the operation value.

2. The method of claim 1, wherein the distortion function is |C_{i,j}−P_{i+x,j+y}|, wherein Cᵢⱼ is the pixel in the encoding block, and P_{i+x,j+y} is the pixel in the search range of the target picture.

3. The method of claim 1, wherein the distortion function is Sum of Squared Difference (SSD) or Sum of Absolute Transform Difference (SATD) function.

4. The method of claim 1, wherein the step (c) multiplies the distortion value and the distribution value to generate the operation value.

5. The method of claim 1, wherein the entropy function is g(|C_{i,j},P_{i+x,j+y}|), wherein Cᵢⱼ is the pixel in the encoding block, and P_{i+x,j+y} is the pixel in the search range of the target picture.

6. The method of claim 1, wherein the entropy function is h(Qp,C_{i,j},P_{i+x,j+y}), wherein Cᵢⱼ is the pixel in the encoding block, and P_{i+x,j+y} is the pixel in the search range of the target picture.

7. The method of claim 6 wherein h(Qp,C_{i,j},P_{i+x,j+y}) is K×f(Qp)×g(|C_{i,j}−P_{i+x,j+y}|), where K is a constant and the function f(Qp) is a monotonic increasing function.

8. The method of claim 6 wherein the larger Qp is, the larger the function h(Qp,C_{i,j},P_{i+x,j+y}) is.

9. A motion estimation device for selecting a target motion vector from a plurality of candidate motion vectors in a search range for an encoding block having a lot of pixels, the device comprising;
a distortion calculator for utilizing a distortion function for calculating difference between the pixels of the encoding block and the pixels in the search range of a target picture to generate at least one distortion value;
a spatial variation calculating module for utilizing an entropy function to calculate the distribution of the difference between the pixels of the encoding block and the pixels in the search range corresponding to candidate motion vectors to generate at least one distribution value; and
a motion vector determining module, coupled with the distortion calculator and the spatial variation calculating module, for operates the distortion value and the distribution value to generate at least one operation value and for determining the target motion vector according to the operation value.

10. The device of claim 9, wherein the distortion function is Sum of Squared Difference (SSD) or Sum of Absolute Transform Difference (SATD) function.

11. The device of claim 9, wherein the motion vector determining module mutiplies the distortion value and the distribution value to generate the operation value.

12. The device of claim 9, wherein the distortion function is |C_{i,j}−P_{i+x,j+y}|, wherein Cᵢⱼ is the pixel in the encoding block, and P_{i+x,j+y} is the pixel in the search range of the target picture.

13. The device of claim 9, wherein the entropy function is g(|C_{i,j},P_{i+x,j+y}|), wherein Cᵢⱼ is the pixel in the encoding block, and P_{i+x,j+y} is the pixel in the search range of the target picture.

14. The device of claim 9, wherein the entropy function is h(Qp,C_{i,j},P_{i+x,j+y}), wherein Cᵢⱼ is the pixel in the encoding block, and P_{i+x,j+y} is the pixel in the search range of the target picture.

15. The device of claim 14, wherein h(Qp,C_{i,j},P_{i+x,j+y}) can be represented as K×f(Qp)×g(|C_{i,j}−P_{i+x,j+y}|), K being a constant, and function f(Qp) being a monotonic increasing function.

16. The device of claim 15, wherein the spatial variation calculating module comprises:
a first calculator for calculating function g(|C_{i,j}−P_{i+x,j+y}|);
a second calculator for calculating function f(Qp); and
a multiplier coupled with the first calculator and the second calculator for calculating K×f(Qp)×g(|C_{i,j}−P_{i+x,j+y}|).

17. The device of claim 14, wherein the larger Qp is, the larger the function h(Qp,C_{i,j},P_{i+x,j+y}) is.

18. The device of claim 9, wherein the motion vector determining module comprises:
an adder, coupled with the distortion calculator and the spatial variation calculating module for adding the distortion value to the distribution value;
an accumulator, coupled with the adder, for calculating the sum value; and
a determiner, coupled with the accumulator for determining the target motion vector.

19. The device of claim 18, wherein the determiner comprises:
a comparator, coupled with the accumulator, for outputting the target motion vector; and
a storage, coupled with the comparator for storing the minimum value of the sum values that ever appears.
